(19) United States
(12) Patent Application Publication
(10) Pub. No.: US 2009/0036586 A1
(43) Pub. Date: Feb. 5, 2009

(54) HALOGEN GAS-RESISTANT PERFLUORO ELASTOMER MOLDED ARTICLE AND SEALING MATERIAL

(75) Inventors: Hideyuki Shishitani, Shizuoka (JP); Naoya Kuzawa, Hamamatsu-shi (JP); Takeshi Kuboyama, Hamamatsu-shi (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, Tokyo (JP)

(21) Appl. No.: 12/181,709

(22) Filed: Jul. 29, 2008

(30) Foreign Application Priority Data
Jul. 31, 2007 (JP) 2007-199625

(51) Int. Cl. C08L 27/14; C08K 3/30

(52) U.S. Cl. 524/423; 525/359.5; 524/545

(57) ABSTRACT

The present invention provides a halogen gas-resistant perfluoro elastomer molded article obtained by molding and crosslinking a composition comprising: (A) 100 parts by mass of a perfluoro elastomer comprising copolymerization units comprising (A1) a perfluoro olefin; (A2) a perfluorovinyl ether; and (A3) a curing site monomer selected from the group consisting of an olefin fluoride having a nitrile group, a vinyl fluoride ether having a nitrile group and a mixture thereof, the curing site monomer (A3) being contained in an amount of 1.0 to 8.0 mol %; and (B) 0.1 to 10 parts by mass of a specific crosslinking agent represented by the following formula (a).

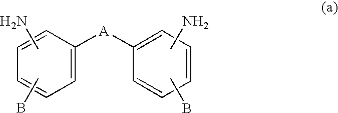

### FIELD OF THE INVENTION

The present invention relates to a perfluoro elastomer molded article which is suitable for use as a sealing material for an apparatus using a halogen gas represented by a fluorine gas, a halogenated gas such as ClF₃, COF₂, NF₃, HF or HCl, or a mixture thereof, such as a semiconductor production apparatus or a liquid crystal production apparatus.

### BACKGROUND OF THE INVENTION

Sealing materials such as a rubber O-ring used in a semiconductor production apparatus, a liquid crystal production apparatus or the like are required to have heat resistance, plasma resistance, chemical resistance, non-sticking property, low gas-release property, low metal-elution property and the like. For this reason, a fluoro elastomer such as a Fluorine rubber is mainly used. Where high level of heat resistance, chemical resistance and plasma resistance is particularly required, a perfluoro elastomer is used (for example, see Patent Document 1).

However, with the trend of high throughput of semiconductor and liquid crystal processes, a halogen-based gas represented by a fluorine gas is recently used under high temperature of 150° C. or higher particularly in a dry process.

It is generally considered that fluoro elastomers such as a fluorine rubber show high corrosion resistance to a halogen-based gas. However, the fluoro elastomers do not have resistance to a halogen-based gas in a high temperature state of 150° C. or higher, and dissolution or gasification of an elastomer is observed. It has been recently reported that when such a fluoro polymer is used in a sealing material, sealing performance is not exhibited.

Patent Document 1: JP-B-63-5409

### SUMMARY OF THE INVENTION

The present invention has an object to solve the above problems. Accordingly, an object of the invention is to provide a perfluoro elastomer molded article showing high corrosion resistance to a halogen-based gas in a high temperature state of 150° C. or higher and particularly suitable as a sealing material for a semiconductor production apparatus and a liquid crystal production apparatus.

Other objects and effects of the invention will become apparent from the following description.

As a result of detailed observation regarding deterioration state of an elastomer molded article upon exposure to a halogen gas of 150° C. or higher, the present inventors found that decomposition of the elastomer occurs mainly from a curing site as the starting point. Furthermore, the present inventors found that when a certain kind of a crosslinking agent is added to a perfluoro elastomer comprising a curing site monomer having a nitrile group at the curing site, thereby crosslinking the perfluoro elastomer, heat resistance of the resulting molded article is dramatically improved.

Accordingly, the present invention provides a perfluoro elastomer molded article and a sealing material described below to overcome the above-mentioned problems.

(1) A halogen gas-resistant perfluoro elastomer molded article obtained by molding and crosslinking a composition comprising:

(A) 100 parts by mass of a perfluoro elastomer comprising copolymerization units comprising:
(A1) a perfluoro olefin,
(A2) a perfluorovinyl ether selected from the group consisting of a perfluoro(alkyl vinyl) ether, a perfluoro(alkoxy vinyl) ether and a mixture thereof; and
(A3) a curing site monomer selected from the group consisting of an olefin fluoride having a nitrite group, a vinyl fluoride ether having a nitrile group and a mixture thereof, the curing site monomer (A3) being contained in an amount of 1.0 to 8.0 mol %; and

(B) 0.1 to 10 parts by mass of a crosslinking agent represented by the following formula (a):

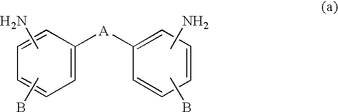

wherein A is a member selected from the group consisting of SO₂, O, CO, a perfluoroalkylene having 1 to 12 carbon atoms, a perfluoroalkenylene having 1 to 12 carbon atoms, a benzene ring, a benzene ring having 1 to 4 members selected from the group consisting of a halogen atom, an amino group, a hydroxyl group, a thiol group, a carboxyl group, a trifluoromethyl group and a methyl group, a heterocyclic ring, and a heterocyclic ring having 1 to 4 members selected from the group consisting of a halogen atom, an amino group, a hydroxyl group, a thiol group, a carboxyl group, a trifluoromethyl group and a methyl group, provided that A may be a single bond, and that A may be a perfluoroalkylene having 1 to 12 carbon atoms and bonded via phenoxy group(s); and B is 1 to 4 members selected from the group consisting of a hydrogen atom, a halogen atom, an amino group, a hydroxyl group, a thiol group, a carboxyl group, a trifluoromethyl group, an alkyl group, a pertluoroalkyl group having 2 to 12 carbon atoms and a perfluoroalkenyl group having 2 to 12 carbon atoms.

(2) The perfluoro elastomer molded article as described in (1) above, wherein the content of the curing site monomer is 2.0 to 4.0 mol %.

(3) The elastomer molded article as claimed in described in (1) or (2) above, further comprising a filler in an amount of 1 to 20 parts by mass per 100 parts by mass of the perfluoro elastomer.

(4) The perfluoro elastomer molded article as described in (3) above, wherein the filler comprises at least one member selected from the group consisting of carbon black, silica, barium sulfate, titanium dioxide, a semicrystalline fluoro polymer and a perfluoro polymer.

(5) A sealing material for a semiconductor production apparatus, comprising the perfluoro elastomer molded article as described in any one of (1) to (4) above.

(6) A sealing material for a liquid crystal production apparatus, comprising the perfluoro elastomer molded article as described in any one of (1) to (4) above.

The perfluoro elastomer molded article of the present invention shows excellent halogen gas resistance and heat resistance by the combination of a specific curing site monomer and a specific crosslinking agent, and can suitably be used under the environment at which a halogen gas is used, particularly in a semiconductor production apparatus, a liquid crystal production apparatus and the like.

### DETAILED DESCRIPTION OF THE INVENTION

The best mode for carrying out the invention is described below.

The perfluoro elastomer molded article of the present invention is obtained by crosslinking and molding a resin composition comprising:

(A) a perfluoro elastomer comprising copolymerization units comprising:
(A1) a perfluoro olefin;
(A2) a perfluorovinyl ether selected from the group consisting of a perfluoro(alkyl vinyl) ether, a perfluoro(alkoxy vinyl) ether and a mixture thereof; and
(A3) a curing site monomer selected from the group consisting of an olefin fluoride having a nitrile group, a vinyl fluoride ether having a nitrile group and a mixture thereof; and

(B) a crosslinking agent represented by the following formula (a):

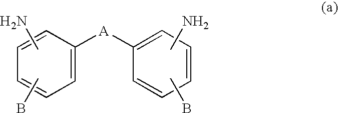

wherein A is a member selected from the group consisting of SO₂, O, CO, a perfluoroalkylene having 1 to 12 carbon atoms, a perfluoroalkenylene having 1 to 12 carbon atoms, a benzene ring, a benzene ring having 1 to 4 members selected from the group consisting of a halogen atom, an amino group, a hydroxyl group, a thiol group, a carboxyl group, a trifluoromethyl group and a methyl group, a heterocyclic ring, and a heterocyclic ring having 1 to 4 members selected from the group consisting of a halogen atom, an amino group, a hydroxyl group, a thiol group, a carboxyl group, a trifluoromethyl group and a methyl group, provided that A may be a single bond, and that A may be a perfluoroalkylene having 1 to 12 carbon atoms and bonded via phenoxy group(s); and B is 1 to 4 members selected from the group consisting of a hydrogen atom, a halogen atom, an amino group, a hydroxyl group, a thiol group, a carboxyl group, a trifluoromethyl group, an alkyl group (preferably a methyl group), a perfluoroalkyl group having 2 to 12 carbon atoms and a perfluoroalkenyl group having 2 to 12 carbon atoms.

In the perfluoro elastomer, the content of unit (A3) is 1.0 to 8.0 mol %, and preferably 2.0 to 4.0 mol %. Where the content of unit (A3) is less than 1.0 mol %, halogen gas resistance becomes poor, and where the content exceeds 8.0 mol %, the hardness of the resulting elastomer molded article becomes too high, and there is the possibility that sealing performance is not exhibited.

The mixing ratio of unit (A1) and unit (A2), i.e., A1:A2, in terms of molar ratio is preferably 80:20 to 50:50, and more preferably 70:30 to 50:50.

Unit (A1) is preferably tetrafluoroethylene. Unit (A2) is preferably perfluoromethyl vinyl ether. Unit (A3) is preferably perfluoro-7-cyano-5-methyl-3,6-dioxa-1-heptene, perfluoro-8-cyano-5-methyl-3,6-dioxa-1-octene, perfluoro-10-cyano-5-methyl-3,6-dioxa-1-decene, perfluoro-11-cyano-5,8-dimethyl-3,6,9-trioxa-1-undecene, and perfluoro-8-cyano-5-methyl-3,6-dioxa-1-nonene.

The perfluoro elastomer can be prepared by blending given amounts of units (A1) to (A3). In this regard, the description of JP-B-63-5409 can be referred to.

The content of component (B) is 0.1 to 10 parts by mass, and preferably 0.5 to 2.0 parts by mass, per 100 parts by mass of the perfluoro elastomer (A). Where the content is less than 0.1 part by mass, crosslinked site lacks, and permanent compression set is increased. Where the content exceeds 10 parts by mass, there arise the problems of decrease in tensile strength, generation of cracks, etc., which are not preferred as a sealing materials.

Component (B) is preferably 2,2-bis(3-amino-4-hydroxyphenyl)hexafluoropropane, 2,2-bis(3-amino-4-methylphenyl)hexafluoropropane and 2,2-bis(3,4-aminophenyl)hexafluoropropane, and particularly preferably 2,2-bis(3-amino-4-hydroxy-phenyl)hexafluoropropane. Plural kinds of component (B) may be used in combination. In such a case, the total amount thereof is set to fall within the above-mentioned amount range for the crosslinking agent.

The resin composition can contain a filler for the purpose of increasing mechanical strength. Among the materials generally known as fillers of an elastomer, any filler can be used so long as it is a filler which does not easily react with a halogen gas to volatilize, or does not adversely affect an elastomer even if reacted with a halogen gas. Carbon black, silica, barium sulfate, titanium dioxide, semicrystalline fluoropolymer and perfluoropolymer are preferred. Of these, carbon black, semicrystalline fluoropolymer and perfluoropolymer are particularly preferred. The filler can be blended in an appropriate amount according to mechanical properties and other properties required as a molded article, but the amount is preferably 1 to 20 parts by mass per 100 parts by mass of the perfluoro elastomer.

According to need, thickeners, pigments, coupling agents, antioxidants, stabilizers and the like can be blended in appropriate amounts, respectively. However, if materials having poor halogen gas resistance are added, there is the possibility that the halogen gas resistance of the whole molded article might deteriorate. Therefore, care should be taken.

Concerning molding and crosslinking conditions, heating at 100 to 250° C. for 10 minutes to 5 hours is preferred. Furthermore, it is preferred to conduct secondary crosslinking, which is preferably carried out by heating at 150 to 300° C. for 1 to 100 hours. The crosslinking and molding can be conducted using an electric furnace or the like.

### EXAMPLES

The present invention will be illustrated in greater detail below with reference to the following Examples, but the invention should not be construed as being limited thereto.

### Examples 1 to 8 and Comparative Examples 1 and 2

According to the formulations shown in Table 1, the components were kneaded in open rolls, heat-treated at a temperature of 190° C. for 20 minutes to conduct primary crosslinking, and then heat-treated at 240° C. for 48 hours to conduct secondary crosslinking and molding. The shapes of the molded articles obtained were a sheet of 100 mm×100 mm×6 mm (thickness), and an O-ring (JIS P-26).

Polymers used in Examples 1 to 8 and Comparative Examples 1 and 2 were obtained by the following procedures. Given amounts of distilled water, ammonium perfluorooctanate and Na₂HPO₄.12H₂O were charged in a stainless steel autoclave. The inside of the autoclave was replaced with nitrogen gas, and pressure of the inside was reduced. The autoclave was cooled to 50° C., and given amounts of tetrafluoroethylene, perfluoromethyl vinyl, and perfluoro-8-cyano-5-methyl-3,6-dioxa-1-octene were charged in the autoclave, respectively. The temperature of the autoclave was elevated to 80° C., and given amounts of sodium sulfite and ammonium persulfate in the form of aqueous solution were charged in the autoclave, respectively, to start polymerization. The polymerization was continued for 20 hours, and unreacted gas was purged. An aqueous latex formed at the bottom of the autoclave was taken out, and salted out with a 10% sodium chloride aqueous solution, followed by drying, thereby obtaining a crumb rubber-like ternary copolymer. The composition of the respective ternary copolymers obtained was confirmed by infrared absorption analysis.

The crosslinking agents used were as follows (all manufactured by AZmax Co.).

### Crosslinking Agent 1:

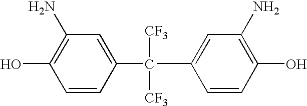

### Crosslinking Agent 2:

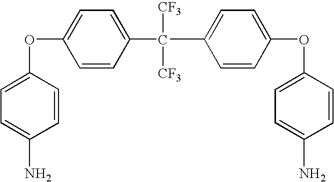

### Crosslinking Agent 3:

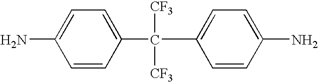

### Crosslinking Agent 4:

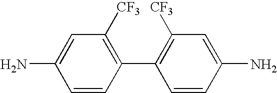

### Crosslinking Agent 5:

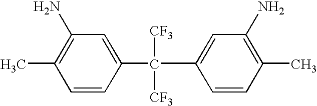

### Comparative Example 3

A peroxide-crosslinking perfluoro elastomer DAIEL GA55, manufactured by Daikin Industries, Ltd., was heat-treated at a temperature of 170° C. for 10 minutes to perform primary crosslinking, and then heat-treated at 180° C. for 4 hours to perform secondary crosslinking and molding. The molded articles obtained were a sheet having 100 mm×100 mm×6 mm (thickness) and an O-ring (JIS P-26).

Measurement of tensile strength and elongation, permanent compression set test and fluorine gas exposure test were conducted to the perfluoro elastomer molded articles obtained above. The results are shown in Table 1.

### Evaluation Method

Tensile strength and elongation: According to JIS

Permanent compression set: According to JIS K6262. However, the conditions used are 200° C. and 72 hours.

Fluorine gas exposure test: JIS P-26 O-ring was cut to form one linear object having circular cross-section. A linear portion having a length of 50 mm was cut from the linear object, and divided into two in the axial direction to obtain a half-cylinder test piece. The test piece was set in a chamber, and fluorine gas having a concentration of 20% (80% nitrogen) was introduced into the chamber. The chamber was heated to the inner temperature of 200° C., and maintained for 1 hour. Evaluation was made based on the change of appearance of the test piece before and after exposure in accordance with the following criteria.

A: No change appears.

B: Slight roundness appears at corners of test piece.

C: Whole surface of test piece melts.

TABLE 1

| | | | | | | | | | | Com. | Com. | Com. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 | Ex. 3 |
| Perfluoro | (A1) Perfluoroethylene | 48 | 48 | 48 | 48 | 48 | 48 | 66.75 | 67 | 67.2 | 67 | DAIEL |
| elastomer | (A2) Perfluoromethyl vinyl ether | 49 | 49 | 49 | 49 | 49 | 49 | 31.75 | 32 | 32.2 | 32 | GA55 |
| (mol %) | (A3) Perfluoro-8-cyano-5-methyl- | 3 | 3 | 3 | 3 | 3 | 3 | 1.5 | 1 | 0.6 | 1 | |
| | 3,6-dioxa-1-octene | | | | | | | | | | | |
| Crosslinking | Crosslinking agent 1: | 1 phr | — | — | — | — | 1 phr | 1 phr | 1 phr | 1 phr | — | |
| agent | 2,2-bis(3-amino-4-hydroxy- | | | | | | | | | | | |
| | phenyl)hexafluoropropane | | | | | | | | | | | |
| | Crosslinking agent 2: | — | 1.5 phr | — | — | — | — | — | — | — | — | |
| | 2,2-bis[4-(4-aminophenoxy)- | | | | | | | | | | | |
| | phenyl]hexafluoropropane | | | | | | | | | | | |
| | Crosslinking agent 3: | — | — | 0.9 phr | — | — | — | — | — | — | — | |
| | 2,2-bis(4-aminophenyl)- | | | | | | | | | | | |
| | hexafluoropropane | | | | | | | | | | | |
| | Crosslinking agent 4: | — | — | — | 0.9 phr | — | — | — | — | — | — | |
| | 2,2-bis(trifluoromethyl)-benzidine | | | | | | | | | | | |
| | Crosslinking agent 5: | — | — | — | — | 1 phr | — | — | — | — | — | |
| | 2,2-bis(3-amino-4-methyl- | | | | | | | | | | | |
| | phenyl)hexafluoropropane | | | | | | | | | | | |
| | Tetraphenyl tin | — | — | — | — | — | — | — | — | — | 10 phr | |
| Filler | MT carbon | — | — | — | — | — | 20 phr | 20 phr | 20 phr | 20 phr | 20 phr | |
| Physical | Tensile strength (MPa) | 4.4 | 5.6 | 6.0 | 4.1 | 4.7 | 17.1 | 18.6 | 21.9 | 18.5 | 13.2 | 12.3 |
| property | Elongation at break (%) | 153 | 172 | 202 | 182 | 213 | 130 | 100 | 170 | 170 | 170 | 120 |
| | 100% Modulus (MPa) | 1.7 | 2.0 | 1.5 | 1.4 | 1.3 | 10.1 | 17.5 | 9.9 | 8.5 | 7.8 | 7.7 |
| | Hardness | 65 | 66 | 65 | 63 | 63 | 80 | 87 | 83 | 82 | 75 | 77 |
| | Fluorine gas resistance | A | A | A | A | A | A | B | B | C | C | C |
| | (200° C., 1 hour, 20% F₂, | | | | | | | | | | | |
| | 0.1 MPa) | | | | | | | | | | | |

As shown in Table 1, the molded articles of Examples 1 to 8 did not substantially melt in the fluorine gas exposure test, and retained good resistance. In particular, the molded articles of Examples 1 to 6 did not show any change in the fluorine gas exposure test, and retained excellent resistance. Furthermore, the molded articles of Examples 6 to 8 had increased mechanical strength by containing a filler.

On the other hand, with the molded article of Comparative Example 1 in which the composition ratio of the curing site monomer having a nitrile group is less than 1.0 mol %, the whole test piece melted in the fluorine gas exposure test. With the molded article of Comparative Example 2 in which a crosslinking agent represented by the formula (a) is not used, the whole test piece melted in the fluorine gas exposure test. With the molded article of Comparative Example 3 in which a curing site monomer having a nitrile group and a crosslinking agent represented by the formula (a) are note used, the test piece remarkably melted in the fluorine gas exposure test.

While the present invention has been described in detail and with reference to specific embodiments thereof, it will be apparent to one skilled in the art that various changes and modifications can be made therein without departing from the spirit and scope thereof.

This application is based on Japanese Patent Application No. 2007-199625 filed on Jul. 31, 2007, and the contents thereof are herein incorporated by reference.

1. A halogen gas-resistant perfluoro elastomer molded article obtained by molding and crosslinking a composition comprising:
(A) 100 parts by mass of a perfluoro elastomer comprising copolymerization units comprising:
(A1) a perfluoro olefin;
(A2) a perfluorovinyl ether selected from the group consisting of a perfluoro(alkyl vinyl) ether, a perfluoro(alkoxy vinyl) ether and a mixture thereof; and
(A3) a curing site monomer selected from the group consisting of an olefin fluoride having a nitrile group, a vinyl fluoride ether having a nitrile group and a mixture thereof, the curing site monomer (A3) being contained in an amount of 1.0 to 8.0 mol %; and
(B) 0.1 to 10 parts by mass of a crosslinking agent represented by the following formula (a): 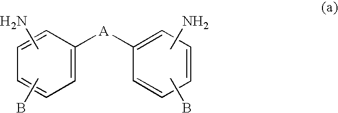
wherein A is a member selected from the group consisting of SO₂, O, CO, a perfluoroalkylene having 1 to 12 carbon atoms, a perfluoroalkenylene having 1 to 12 carbon atoms, a benzene ring, a benzene ring having 1 to 4 members selected from the group consisting of a halogen atom, an amino group, a hydroxyl group, a thiol group, a carboxyl group, a trifluoromethyl group and a methyl group, a heterocyclic ring, and a heterocyclic ring having 1 to 4 members selected from the group consisting of a halogen atom, an amino group, a hydroxyl group, a thiol group, a carboxyl group, a trifluoromethyl group and a methyl group, provided that A may be a single bond, and that A may be a perfluoroalkylene having 1 to 12 carbon atoms and bonded via phenoxy group(s); and B is 1 to 4 members selected from the group consisting of a hydrogen atom, a halogen atom, an amino group, a hydroxyl group, a thiol group, a carboxyl group, a trifluoromethyl group, an alkyl group, a perfluoroalkyl group having 2 to 12 carbon atoms and a perfluoroalkenyl group having 2 to 12 carbon atoms.

2. The perfluoro elastomer molded article as claimed in claim 1, wherein the content of the curing site monomer is 2.0 to 4.0 mol %.

3. The perfluoro elastomer molded article as claimed in claim 1, further comprising a filler in an amount of 1 to 20 parts by mass per 100 parts by mass of the perfluoro elastomer.

4. The perfluoro elastomer molded article as claimed in claim 3, wherein the filler comprises at least one member selected from the group consisting of carbon black, silica, barium sulfate, titanium dioxide, a semicrystalline fluoro polymer and a perfluoro polymer.

5. A sealing material for a semiconductor production apparatus, comprising the perfluoro elastomer molded article as claimed in claim 1.

6. A sealing material for a liquid crystal production apparatus, comprising the perfluoro elastomer molded article as claimed in claim 1.
